(19) United States
(12) Patent Application Publication
(10) Pub. No.: US 2024/0420552 A1
(43) Pub. Date: Dec. 19, 2024

(54) Portable Device for Visually Indicating Portable Computing Device Data

(71) Applicant: WhitServe LLC / Lights Out, Stamford, CT (US)

(72) Inventor: Declan Wesley Whitmyer, Stamford, CT (US)

(21) Appl. No.: 18/742,787

(22) Filed: Jun. 13, 2024

Related U.S. Application Data
(60) Provisional application No. 63/508,115, filed on Jun. 14, 2023.

(51) Int. Cl. G08B 5/36; F21V 5/00; F21V 23/00; F21Y 113/13; F21Y 115/10

(52) U.S. Cl. CPC G08B 5/36; F21V 5/007; F21V 23/009; F21Y 2113/13; F21Y 2115/10

(57) ABSTRACT

A portable device for visually indicating portable computing device data via an array of lamps, each lamp including a plurality of individually controllable LEDs, a driver circuit for separately powering each of the LEDs, such that each lamp can project light of a different color or intensity, a receiver for wirelessly receiving portable computing device data indicative of information for visual representation, and a battery for powering the receiver and the driver circuit. A system is also provided in which an SDK is provided portable device, and mobile phone apps use the SDK to represent status data with the LEDs.

### TECHNICAL FIELD

The invention provides a system enabling a portable device to visually display information from an app running on a mobile device via an array of LED lamps connected to the mobile device.

### BACKGROUND

As portable computing devices become more sophisticated, they collect ever more data that needs to be communicated to the user. Some data is entered by the user, some is sensed directly by the smartphone, and still more data may be received to the smartphone by a third-party hardware sensor or other device or service. Current mobile apps typically present this data directly on the smartphone screen via notification, which can be intrusive because notifications compete with other data for screen real estate.

Other ways portable computing devices can alert users to the arrival of new data are via sound and/or haptics. Most users leave their smartphones on silent mode for the same reason they do not want to see notifications covering part of their screen—it is intrusive.

In other environments, such as sports, where smartphones and other portable computing devices are only recently starting to replace special purpose electronic equipment, notification options may be entirely non-existent, and a user may not normally be looking at their phone when notifications arrive, yet they need to be notified, at a distance, of the new data. Safety and the level of competition may suffer.

What is desired is to use a portable device for visually indicating portable computing device data.

What is also desired is an LED device connected to the portable computing device to convey status information in a visual manner.

### SUMMARY

Accordingly, the invention provides a portable LED lamp array which can visually represent status data from portable computing device software.

### BRIEF DESCRIPTION OF THE DRAWINGS

FIG. 1A is a front elevation view of an example of an LED light bar according to the invention.

FIG. 1B is a top plan view of the exemplary LED light bar of FIG. 1A.

FIG. 1C is a front elevation of the exemplary LED light bar of FIG. 1 in which the individual lamps are illuminated in a pattern to convey information.

FIG. 2 is a schematic block diagram showing use of the light bar of FIG. 1C in a system wherein an open SDK is used by a portable computing device to convey information from at least one application program.

FIGS. 3, 4, and 5 depict the LED light bar of FIG. 1A in use in various environments respectively including sailing, biking, and home/office.

FIGS. 6A-6F depict examples of using the LED light bar of FIG. 1A to depict information pertinent to a sailboat racing competition.

FIGS. 7A-7B and 8A-8E depict examples of using an LED light bar of FIG. 1A to depict information pertinent to operation of a bicycle, which also may be sensed by the portable computing device (not shown).

FIGS. 9A-9C, 10, 11, and 12A-12C all depict ways of utilizing the LED light bar of FIG. 1A to visually communicate one or pieces of data from a portable communicating device to a user in a home/office environment.

### DETAILED DESCRIPTION

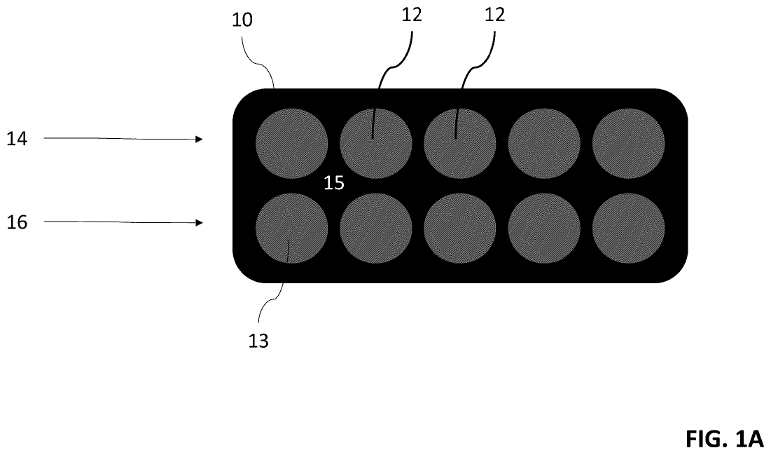

FIGS. 1A-1C show an example of a portable visual indicating device 10 according to the invention. Note that the shape, size, and arrangement of lamps 12 in two rows 14 and 16 is thought to be useful for many end users and informational uses, other arrangements, sizes, and shapes are possible and within the scope of the invention.

Each lamp shown schematically in FIG. 1A and throughout this description as a dot 12 is actually comprised of three to six independent but adjacent light emitting diodes behind a lens 13 mounted in a faceplate 15 comprising one side of LED light bar 10. In this regard, each of the multiple LEDs (not shown) can be driven at different amplitudes such that the visible light generated by each lamp 12 is from the multiple LEDs associated with each lamp 12 to form a color and intensity of choice for visual indication on a lamp-by-lamp basis for each lamp 12 in the array 11.

An array 11 of 10 lamps, preferably arranged in two rows of five lamps, can be used to clearly convey a wide variety of information in a non-intrusive manner. It will be understood that other arrangements of lamps could be used if desired, but it has been found that five lamps in a row are useful to show information trends, as well as sidedness of data (i.e., right, and left side). It has also been found that two rows of lamps can be used either to emphasize data (by visually repeating it in each row) or to indicate two different items of data, i.e., one item per row 14/16 of lamps 12.

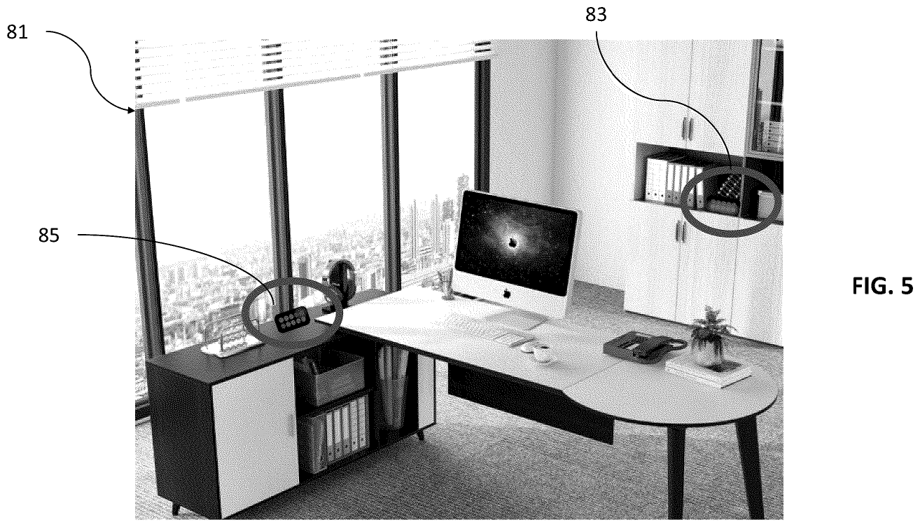

Turning now particularly to FIG. 1B, rows 14′ and 16′ of lamps are shown illuminated in different colors as an example of information presentation. Lamp 12′ is blue, lamp 12″ is white and lamp 12′″ is red. The pattern is symmetrical in the row so, e.g., row 14′ is illuminated blue, white, red, white, blue. As shown, row 16′ repeats row 14′ for emphasis and is illuminated blue, white, red, white, blue. In other words, 12′, 12″, 12′″, 12″, 12′. It is understood that row 16′ could visually indicate a different piece of data instead of repeating the data represented in row 14′. It will be understood to a sailor of ordinary skill, that the pattern shown in FIG. 1B is a “C” flag which indicates a course change. Other sailboat racing signals may also be represented as shown in the series of FIGS. 6A-6F.

A side charging port 18 may also be provided in LED light bar 10, however for certain applications (including sailing) wireless charging may be preferable in order to improve water resistance of LED light bar 10. FIG. 1C shows the other relative dimension of exemplary LED light bar 10, from which it can be seen that the device of the invention may be portable and even hand-holdable if desired for a particular application. Since the device is designed to indicate data from portable computing devices (PCD), its size may be dimensioned according to its use and application.

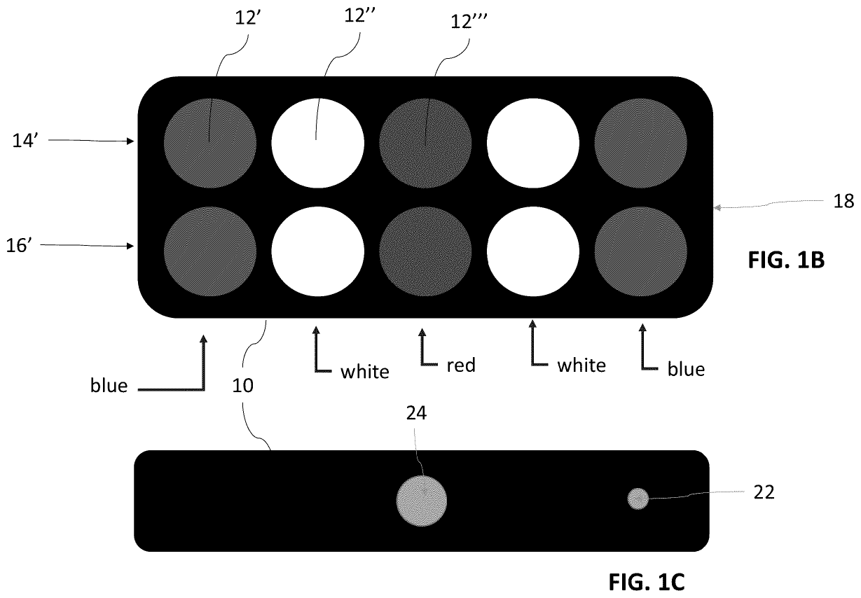

In FIG. 1C, buttons 22 and 24 are shown but one of ordinary skill will appreciate that one or three or more buttons may be used as desired. Button 22 as illustrated is for pairing LED light bar 10 to a particular PCD 32 (see FIG. 2) for visually indicating data representing status or notifications for an application program (app) running on that particular PCD. PCD pairing may be achieved by Bluetooth, NFC, WiFi, or otherwise in order that data from a particular PCD is visually indicated on LED light bar 10.

Button 22 is not necessary, and its function may be performed by button 24 or otherwise within the scope of the invention. Button 24 as shown preferably has multiple purposes which may include brightness/dimmer, power on/off, user pages/settings, and even pairing. To achieve these different purposes, button 24 may be pressed, pressed, and held, double pressed, twisted, pressed and twisted, and the like, in combinations to access all desired functions. The dimmer can adjust lamp brightness for ambient lighting conditions.

Referring now to FIG. 2, a system 30 is schematically shown in which exemplary LED light bar 10 visually presents information such as status and notifications from application programs (apps) 34 running on PCD 32. Apps 34 may be particularly programmed by developers 36 to leverage a software development kit (SDK) 38 provided by manufacturer 40 of LED light bar 10. SDK 38 is advantageously “open” and provided free of charge by manufacturer 40 in order to promote development of apps 34 to utilize LED light bar 10 to visually indicate app status and notifications. SDK 38 enables the apps 34 to send wireless signals to the light bar 10 for controlling its lamp configurations. In this way, utilizations of LED light bar 10 is limitless and developers can creatively drive demand for use of visual indication with their many different types of PCD apps.

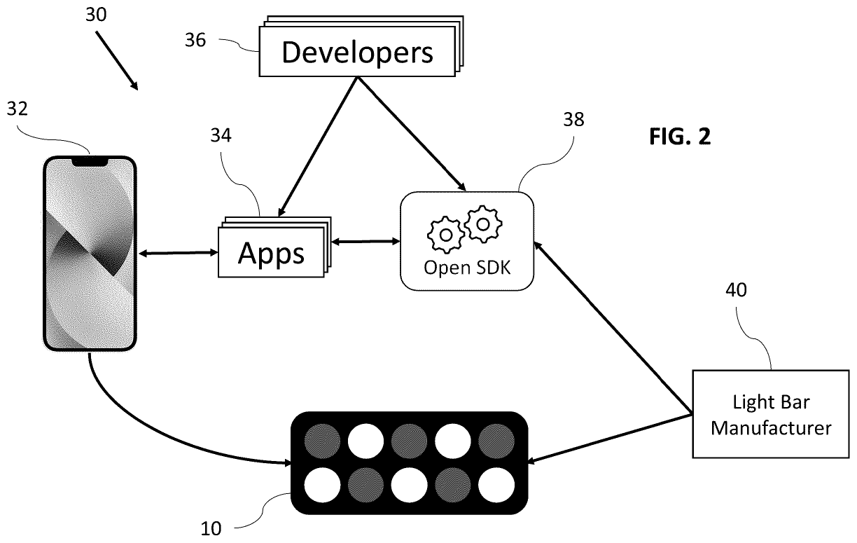

FIGS. 3, 4 and 5 illustrate use of the LED light bar 10 as in the exemplary respective sport environments of sailing and cycling, as well as the home/office environment. FIG. 3 shows use of an LED light bar on racing sailboat 40 in circles 42 and 44. In circle 42, light bar 10 may be used as a companion to racing instrument 48 providing a visual representation of data either sensed by instrument 48 or received to instrument 48 from a race manager or authority. In circle 44, LED light bar 10 may serve either as a so-called “repeater” displaying the same information as the light bar in circle 42, or the circle 44 light bar may be used to provide a different piece of information more relevant to sailors located in the particular part of the racing sailboat where it is located.

As depicted by pattern 46, the light bars in both circles 42 and 44 are visually representing the same information, namely, signal flag “S” which stands for shortened course and means that the race will end at the next mark. Both rows of the LED light bars are showing the same pattern: blue, blue, white, blue, blue which schematically represents the “S” signal flag to mariners. Other signal flags and their LED light bar 10 equivalents are shown in FIGS. 6A-6F. Depicting signal flags is an example of data that may be displayed on LED light bar 10 when used with a sailboat racing app such as for example, the “Lights Out” sailboat racing app. It is understood that other sports and other PCD apps may use the LED light bar in a different way to visual present different information representing status, notifications and the like for both sport and work/home applications.

It is also understood in the example of FIG. 3 that the “S” flag instruction was received on racing sailboat 40 from a race manager to sailing instrument 48 (which may be provided as a special purpose sailboat racing instrument or a programmed smartphone), and then sailing instrument 48 decoded the instruction via to drive LED light bar 10 via SDK 38. In another sailboat racing use case, LED light bar 10 may display data sensed or tracked by sailboat racing instrument 48 (whether it is a special purposes of programmed smartphone). Sensed data might include lifts or headers, and time to start, while instructions are normally represented by signal flags in context of sailboat racing.

FIGS. 6A-6F provide examples of how common sailboat racing signal flags could be replicated with two rows of 5 lamps. FIG. 6A shows the “P” flag which is used as a 4-minute signal in a normal racing sailboat start. Both rows of lamps in the light bar are illuminated the same: blue, blue, white, blue, blue. FIG. 6B depicts a “Z” flag which can be used in lieu of the “P” flag to start a sailboat race in which boats over the starting line too early receive a 20% of the fleet size penalty. The top and bottom rows of light bar 10 differ to represent the “Z” flag with the top row illuminated: black, yellow, yellow, yellow, blue and the bottom row illuminated: black, red, red, red, blue. Black may conveniently be made by not illuminating the indicated lamp, especially if lens 13 is smoked or tinted.

FIG. 6C shows an “I” flag which is used as an alternate 4-minute signal in racing sailboat start and signifies a starting rule alteration in which racing sailboats that are on the course side of the starting line within one minute of the starting time must sail around one end of the starting line (signal boat or pin) before starting the race in a timely manner. To represent an “I” flag, both rows of lamps in the light bar are illuminated the same: yellow, yellow, black (no light), yellow, yellow pattern. FIG. 6D depicts an “N” flag which signifies that the in-process sailboat race has been abandoned. The “N” signal flag can be represented by alternating blue and white lamps with a top row organized: blue, white, blue, white, blue while the bottom row is alternately illuminated: white, blue, white, blue, white as shown.

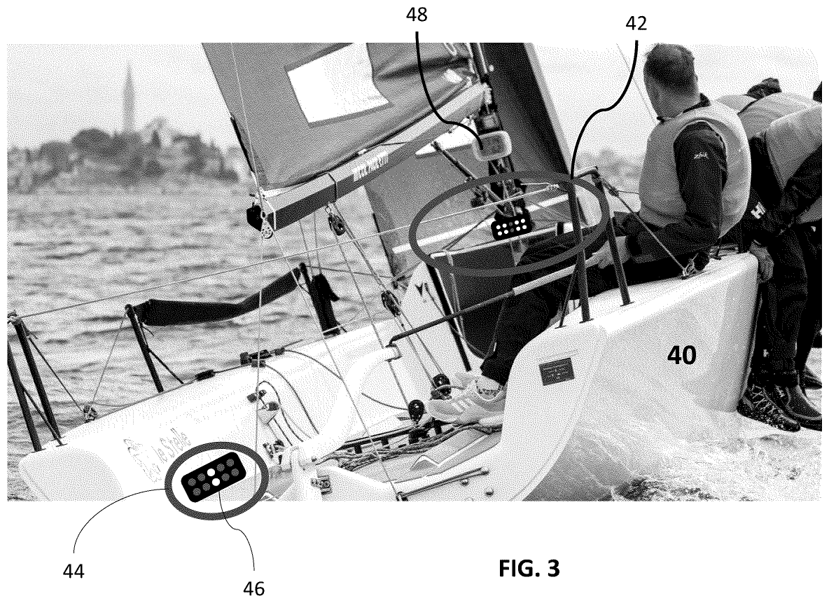

FIG. 6E shows an “X” flag which is used by race managers to signify and communicate to racing sailors that one or more racing sailboats was over the line early. The “X” flag is followed by a list of boat IDs (sail or bow numbers) to inform the racing sailboats which among them started too early and must return behind the line to restart or face disqualification. Purely, in terms of color, the “X” flag is similar to the “S” flag shown in FIG. 4 but with very different meaning. At a distance, in rain and fog, or in rough seas, these and other pairs of signal flags can be difficult to distinguish. Another potentially confusing signal flag pair are the “R” and 1st repeater flags (not shown in any Fig.). With LED Ight bar 10, the “X” flag can be clearly represented with a different pattern in the top and bottom rows of lamps as follows. Top row: white, white, blue, blue, white, and bottom row: white, blue, blue, white, white. Vertically offsetting the blue lamps indicates the blue cross on the “X” and similar other signal flags.

FIG. 6F depicts an “C” flag which signifies that the racecourse for an in-process sailboat race has been changed. Display of the informational “C” signal flag by a race manager is followed by a new compass heading, or new/replacement mark identifier, and may also include a “+” or “−” symbol to indicate that the distance is longer or shorter (due to changing wind patterns or strength). As also shown, in FIG. 1B, the “C” signal flag can be represented by one or two rows of lamps organized: blue, white, red, white, blue. It will be understood that some signal flags can be represented by a single row of 5 lamps, while others require two rows for clarity. In cases where a single row is needed then a second piece of data could be visually represented in the second row. As an example, green lamps in some or all of the bottom row of a top row representing the “C” signal flag could depict a longer leg of the race course, while one or more red lamps in the bottom row could indicate a shorter leg of the race course.

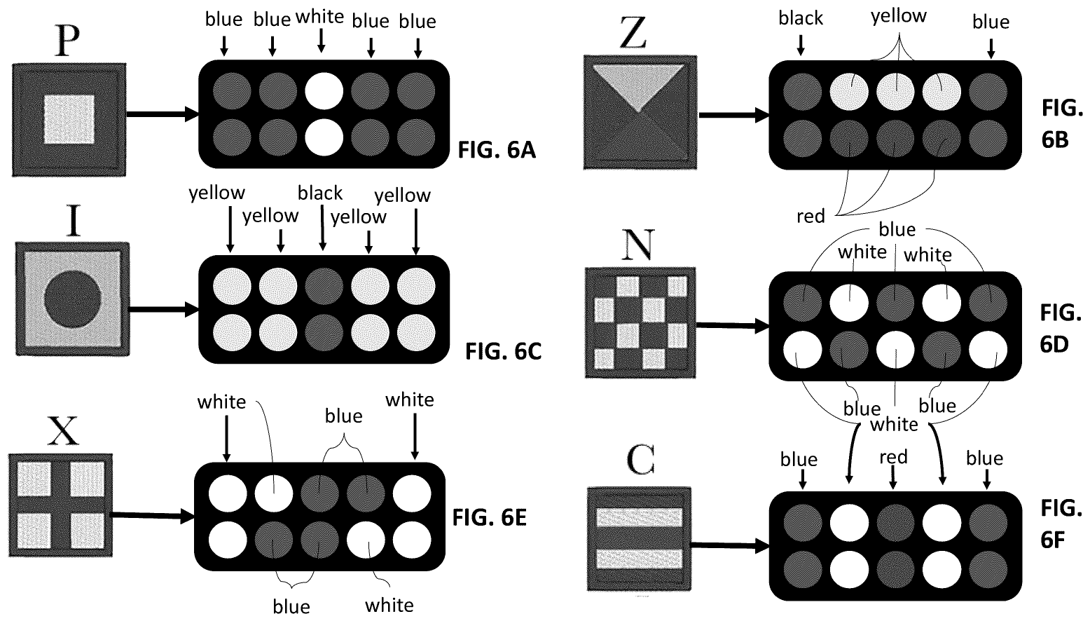

Moving on to FIG. 4, LED light bar 10 is shown in use to convey information relating to another sport, cycling 60. In this contextual use example, light bar 10 visually presents information, not to the sport participant, but to cars and other cyclists for safety reasons. As shown in FIGS. 4 and 7A, all 10 lamps 62 are illuminated red, however as shown in FIG. 7B, the central lamp grouping 64 of array 62 is illuminated more brightly (and may even if desired flash in any number of patterns) in order to communicate that the bicycle is slowing down as sensed by a PCD (not shown in this Fig.) connected to the light bar 10 and carried on the bicycle. Most modern PCDs, and particularly smartphones have built-in accelerometers that could be used for this purpose and a developer of bicycle apps could easily use the SDK to implement this type of feature for use with LED light bar 10.

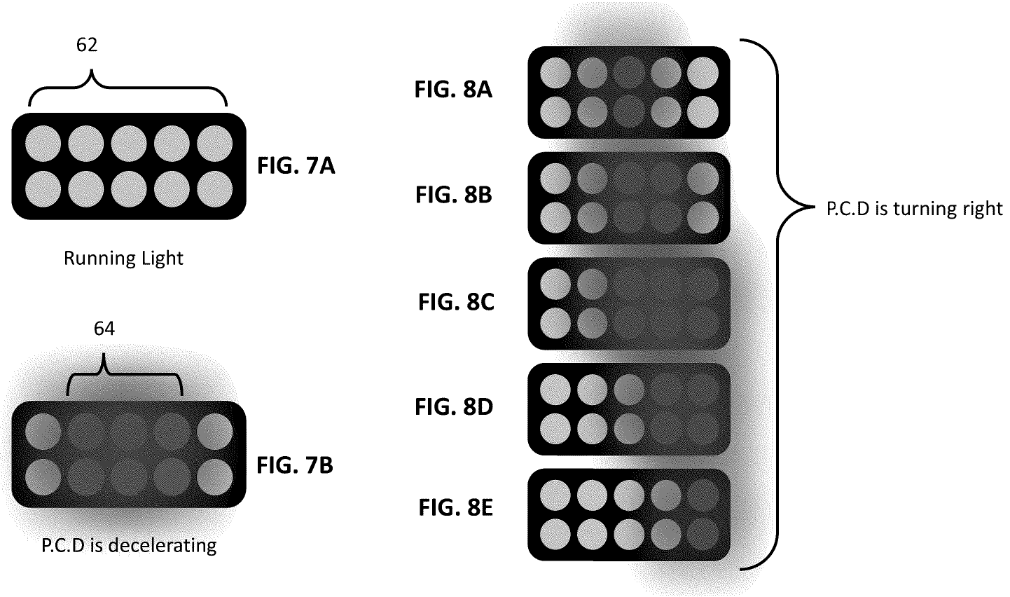

Referring now to FIGS. 8A-8D, an example is provided how LED light bar 10 could be used on a bicycle with cyclist-initiated information for display, namely a turn signal. By, e.g., simply touching or swiping a smartphone or other PCD mounted to e.g., the bike's handlebars, a cyclist could indicate an intention to turn which status information could be illuminated for presentation to cars and other cyclist, again to enhance safety. As depicted in FIG. 8A for a right turn, column 66 would first be brightly illuminated, followed by both columns 66 and 68 (FIG. 8B), followed by all three columns 66, 68 and 70 (FIG. 8C). And then to simulate movement to the right, column 66 can be returned to running light level as shown in FIG. 8D. In FIG. 8E, only the lamps in column 70 remain illuminated. The pattern can be repeated until the turn is complete, which can be conveniently sensed by the accelerometer in PCD 32. It is understood that many other patterns are possible, and the invention is not limited by this example.

It is also understood that the visual indication bar 10 can be mounted to many other examples of sports equipment, or to the wrist of an athlete with elastic bands, hook, and loop fasteners, and the like. Beyond sports uses, LED light bar 10 can simply be mounted on a tripod or just placed on a table. The environment in which it provides visual indication is limited only by the developer's imagination in incorporating the SDK into their PCD app.

Another important aspect of this invention is that any shortcomings of screen visibility in direct sunlight of a portable computing device are easily overcome by accessory lamps using LEDs for illumination according to the invention. An array of such lamps, each formed from an array of LEDs are low power, easy to see, easy to repeat, and can be used to convey mobile app status information more efficiently than sounds or screen notifications.

Each lamp shown schematically in the Figures as a dot 12 is comprised of three to six independent but adjacent light emitting diodes, each of which can be driven at different amplitudes such that the visible light generated by each is blended to form a color and intensity of choice for separate visual indication of each lamp on a lamp-by-lamp basis for each lamp in the array to convey information. LED light bar 10 is a communication device, not a mere illumination device. The information conveyed is determined by the developer and may even be user controllable via app settings.

An array or matrix of 10 lamps can be used to clearly convey a wide variety of information in a non-intrusive manner. The information may recreate graphical images such as a signal flag, or they may convey status and notification information from a PCD using lamp color, location, intensity, number, and the like, and combinations of these, to convey information. In addition, the exemplary ten lamp dots array schematically shown and described herein can all be located behind a single lens or diffuser within the scope of the invention. But, preferably, each of the ten lamps has its own lens for projecting light of its own intensity and color independent of the other lamps in the array or matrix of nine or more.

An app built for portable computing device 32 can not only access data sensed directly by the device gyro, accelerometer, GPS receiver and the like for display, but can also indicate when new or important data has bene received by an app running on the PCD. Software Development Kit, API, or the like 38 for the device allows developers 36 to build apps to drive visual indicators such as LED lamp 12 arrays to provide coded messages simultaneously to one or multiple users.

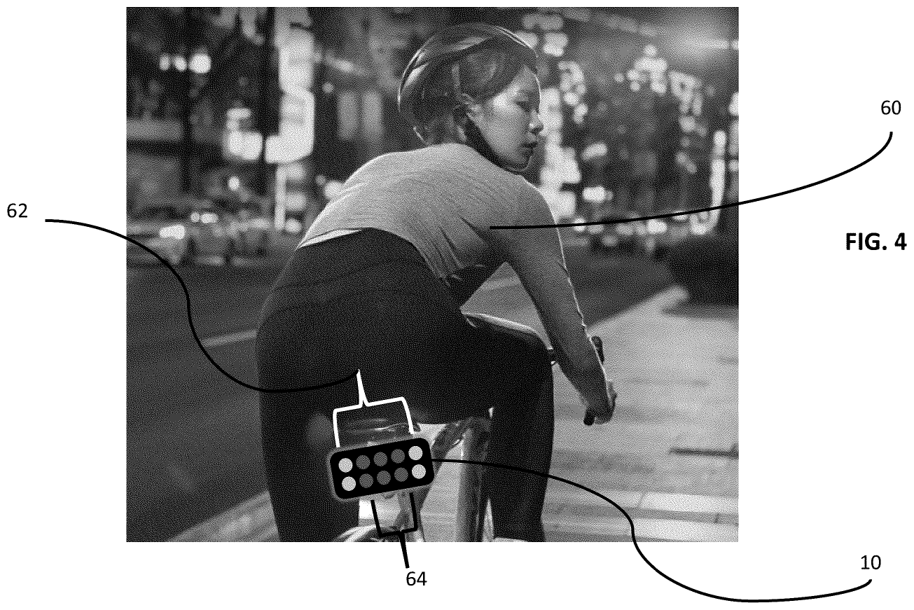

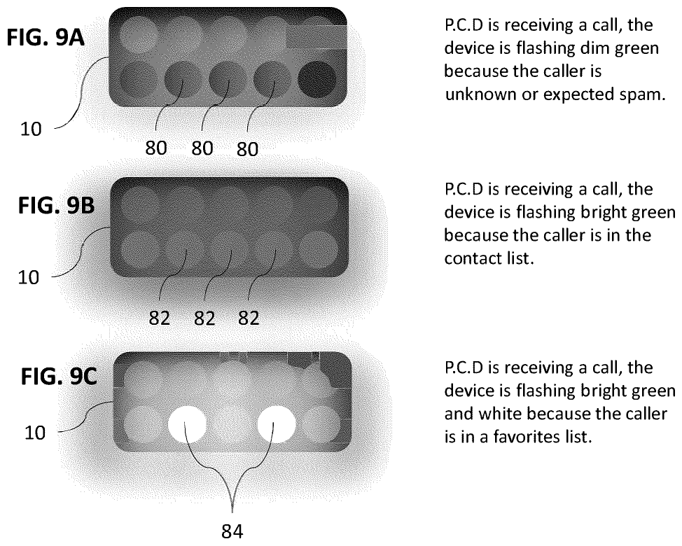

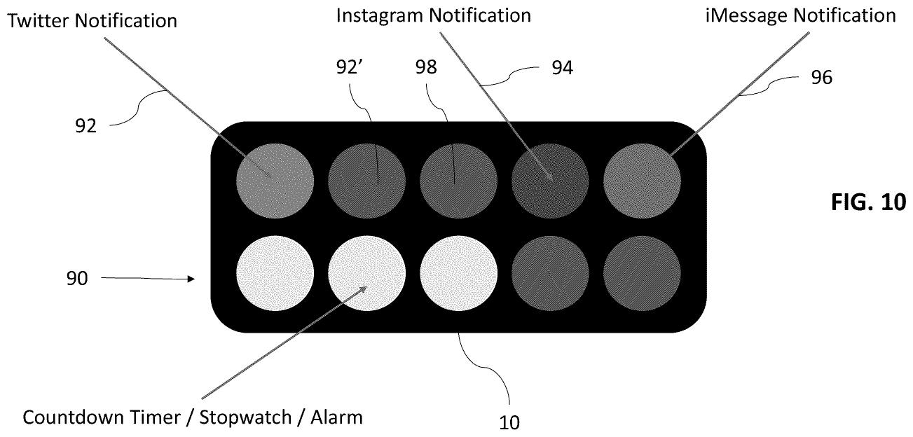

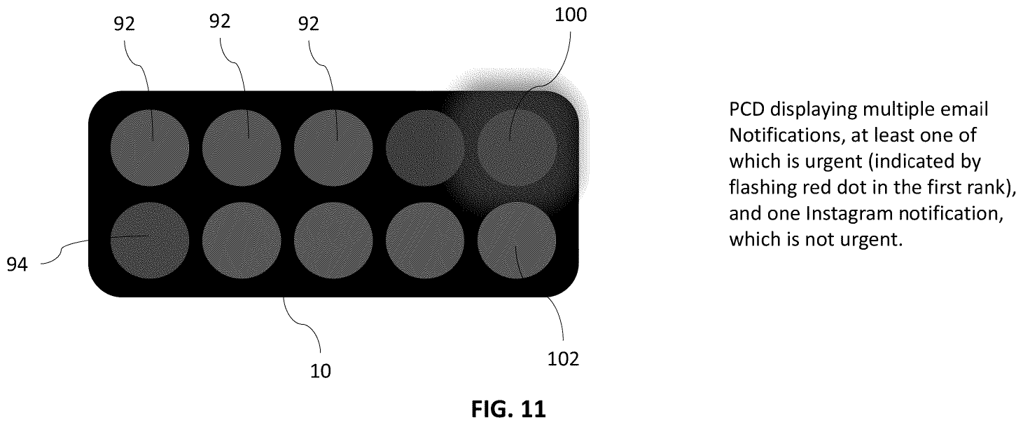

Referring now to FIG. 5, LED light bar 10 is shown in a home/office 80 setting located e.g., in circles 82 and 84. In circle 82 and FIGS. 9A-9C, light bar 10 is used to visually indicate telephone calls received on PCD 32, while in circle 84 and FIGS. 10-11, light bar 10 is used to visually indicate status and notifications from social media and other apps running on PCD 32.

Turning first to FIGS. 9A-9C, a visual indication system is proposed to signal an incoming call. In the example, one or lamps is illuminated green at 80 and may also flash. The relatively dim intensity of green lamps 80 indicate that the incoming call is not from a known contact person as determined by the PCD attached to LED light bar 10. If the incoming call is from a spam list, the lights may simply illuminate a dim red or not at all (not shown). By comparison, in FIG. 9B, green lamps 82 are bright (and may also flash) to indicate that the call is from a known contact person. Finally, in FIG. 9C, incoming calls from a favorite list on the PCD can include the addition of one or more flashing white lamps 84 in addition to the green lamps consistent with PCS contacts. Instead of white, the green lamps could also flash for favorites to distinguish them from mere contacts. The point of this example is that developers 36 can use SDK 38 in myriad ways to convey information to users from LED light bar 10.

FIG. 10 provides other examples of using LED light bar 10 in a home/office setting. In this example, each row of lamps is used for a different type of data. The bottom row includes one to five lamps illuminated yellow 90 to indicate time, e.g., a snooze mode, kitchen, or other timing device in which case each lamp may represent one or more, user-settable minutes. At the same time, the top row of lamps indicates various notifications color-coded to social media and messaging apps on PCD 32. Blue represents Twitter and a blue lamp 92 means a new twitter notification has been received, while a pink/purple lamp 94 indicates a new Instagram notification, and a green lamp 96 indicates a new iMessage, notification or the like. One of ordinary skill will understand that the colors and lamp(s) assigned to each type of notification can either be assigned by developers or set by users. In this regard, it can be understood that black lamp 98 could be assigned to Slack or some other application notification, while black light 92′ may be assigned and waiting for a second twitter notification. Brightness of each of these notifications could indicate the number of received messages, and or they could flash after a certain number, or they could flash their color alternating with white for emphasis after a very large number indicating some urgency. All of this could be programmed or user settable.

Referring now to FIG. 11, a different arrangement of lamps is proposed to convey information in a home/office setting. Lamps 92 are illuminated blue in the top row/rank to indicate three Twitter notifications have been received, but lamp 100 is also illuminated red, which may be bright or flashing, to signify that one or more of the twitter notifications is urgent. By urgent is meant that it is from a friend, or is an emergency or some other factor that could be either user-assignable or developer-determined. A single lamp 94 is pink/purple in the bottom row/rank indicating e.g., a single Instagram notification has been received, but lamp 102 is not red so the Instagram notification is not “urgent”. Obviously, many other arrangements are possible and within the scope of the invention which invites creative use of LED light bar 10.

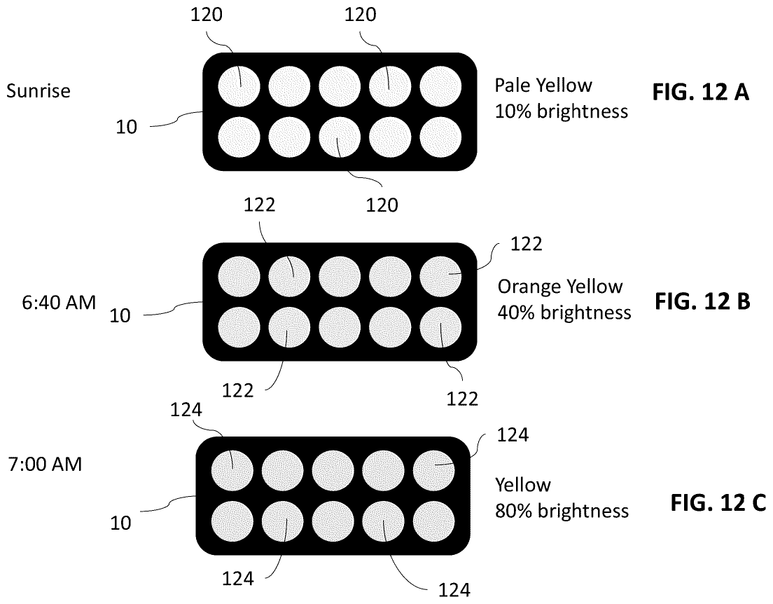

Turning now to FIGS. 12A-12C, use of LED light bar 10 in a home as a sunrise alarm clock is illustrated. As shown in FIG. 12A, at e.g., sunrise or some other defined time, one or all of lamps 120 begin to glow e.g., yellow. The color could be user-selected or automatic based on the weather or sky color. As time passes, according to a script preferably chosen by the user, the lamps 122 get brighter and may also change color as shown in FIG. 12B. Then as illustrated in FIG. 12C, the process may continue in additional steps with lamps 124 continuing to get brighter and/or change shade to slowly wake a user and/or to let them know the weather as they naturally arise.

An important aspect of the invention is the portable, hand-holdable nature of LED light bar 10. Because it is easy to transport and wireless, it can be carried by a user from place to place. It can be mounted to sport equipment of different kinds and used in different rooms of a home. It can visually impart data to a user of different kinds depending upon where the device is located, the time of day, where it is mounted, and what apps are running on PCD to which it is connected. It can be mounted or simply rest on a table or desk. The wide range of use makes it impossible to describe all possible uses within the scope of the invention.

Another data which may be generated by the smartphone for display via screen, visual lamp bar or other visual indication is time. If the light bar product includes a GPS chip, it can be time synchronized e.g., with ither sport competitors via the PCD processor for mutual precision display timing.

Alternatively, individual ranks or rows of lamps could indicate a different piece of data, or they could both indicate the same piece of data. In case they indicate different pieces of data it is suggested that one row might indicate time while the other one or more rows might indicate status of an event.

It will be understood to one of ordinary skill, that the lamp signaling aspect of the invention can be used even if the portable computing device is not in view. In such a system, the visual indication bar itself can illuminate according to informational signals received.

This description and the appended Figs. are meant to be exemplary. The description is not meant to be limiting or describe requirements of the invention, only examples, and accordingly do not limit the scope of the invention as claimed below.

What is claimed is:

1. A portable device for visually indicating portable computing device data, comprising:
a housing;
an array of lamps mounted in said housing, each lamp in said array including a plurality of individually controllable LEDs;
a plurality of lenses arranged with a single one of said plurality of lenses proximal to each one of said array of lamps;
a driver circuit for separately powering each of said plurality of LEDs in each lamp of said array, such that each lamp can project light of a different color or intensity through its associated lens without regard to other lamps of said array of lamps,
a receiver in said housing for wirelessly receiving portable computing device data indicative of information for visual representation; and
a battery mounted in said housing for powering said receiver and said driver circuit.

2. The portable visual indicating device of claim 1 wherein said array of lamps further comprises two rows of five lamps.

3. The portable visual indicating device of claim 1 wherein each lamp of said array of lamps includes at least four separately controllable LEDs.

4. The portable visual indicating device of claim 3 wherein each lamp of said array of lamps includes six separately controllable LEDs.

5. The portable visual indicating device of claim 1 in which a position of an illuminated lamp in said array of lamps conveys information.

6. The portable visual indicating device of claim 1 in which a color of an illuminated lamp in said array of lamps conveys information.

7. The portable visual indicating device of claim 1 in which an intensity of an illuminated lamp in said array of lamps conveys information.

8. The portable visual indicating device of claim 1 in which a visual effect of an illuminated lamp in said array of lamps conveys information.

9. The portable visual indicating device of claim 1 wherein said receiver is a Bluetooth receiver.

10. The portable visual indicating device of claim 1 wherein said receiver is a Wi-Fi receiver.

11. The portable visual indicating device of claim 1 wherein at least one lamp of said array of lamps projects light of a different color than at least one other lamp of said array of lamps.

12. The portable visual indicating device of claim 1 further comprising a satellite receiver for receiving a current time from a satellite.

13. The portable visual indicating device of claim 1 wherein said receiver receives a future time signal from the portable computing device.

14. The portable visual indicating device of claim 1 wherein said the future time determines when the portable computing device data is visually represented.

15. The portable visual indicating device of claim 1 wherein the portable computing device data represents the status of a software running on the portable computing device.

16. The portable visual indicating device of claim 15 wherein the app uses an SDK for said portable device to visually represent the app status data.

17. A system for visual indication of portable computing device data, comprising:
a portable device including:
a housing,
an array of lamps mounted in said housing, each lamp in said array including a plurality of individually controllable LEDs,
a driver circuit for separately powering each of said plurality of LEDs in each lamp of said array, such that each lamp can project light of a different color or intensity,
a receiver in said housing for wirelessly receiving portable computing device data indicative of information for visual representation, and
a battery mounted in said housing for powering said receiver and said driver circuit;
an SDK for said portable device; and
a mobile phone app programmed using said SDK to represent status data from said app on said portable device.

18. A portable device for visually indicating data, comprising:
a housing;
an array of lamps mounted in said housing, each lamp in said array including a plurality of individually controllable LEDs;
a plurality of lenses arranged with a single one of said plurality of lenses proximal to each one of said array of lamps;
a driver circuit for separately powering each of said plurality of LEDs in each lamp of said array, such that each lamp can project light of a different color or intensity through its associated lens without regard to other lamps of said array of lamps,
a receiver in said housing for wirelessly receiving data indicative of information for visual representation; and
a battery mounted in said housing for powering said receiver and said driver circuit.

19. A portable device for visually indicating data, comprising:
a housing including a battery;
an array of spaced-apart lamps mounted in said housing and powered by the battery, each lamp in said array including a plurality of individually controlled LEDs;
a faceplate on one side of said housing having an array of spaced-apart holes matching said array of spaced-apart lamps mounted there-beneath;
a plurality of lenses arranged with one of said plurality of lenses mounted in each of said plurality of holes and proximal to each lamp of said array of lamps;
a receiver in said housing for receiving data from a portable computing device for visual indication via said array of lamps, the data including in which color each of the plurality of lamps should be illuminated to visually convey the data;
a driver circuit in said housing for separately powering each of said plurality of LEDs in each lamp of said array of lamps according to the data received from the portable computing device, such that at least two lamps of said array of lamps project light of a different color or intensity at the same time through their respective spaced-apart holes in said faceplate.

20. A portable device for visually indicating data, comprising:
a housing including a battery;
an array of spaced-apart lamps mounted in said housing and powered by the battery, each lamp in said array including a plurality of individually controlled LEDs;
a faceplate on one side of said housing having an array of spaced-apart holes matching said array of spaced-apart lamps mounted there-beneath;
a plurality of lenses arranged with one of said plurality of lenses mounted in each of said plurality of holes and proximal to each lamp of said array of lamps;
a receiver in said housing for receiving data from a portable computing device for visual indication via said array of lamps, the data including in which color a single one of the plurality of lamps should be illuminated to visually convey the data;
a driver circuit in said housing for separately powering each of said plurality of LEDs in the single one of said array of lamps according to the data received from the portable computing device, such that the single one of said array of lamps projects light of the indicated color through its respective spaced-apart hole in said faceplate.

21. A visual notification device comprising:
a plurality of colored lamps that are spaced apart within a light bar body;
a lamp driver that receives one of a plurality of pre-determined signals and controls the plurality of lamps in response to the received signal;
a software developer kit (SDK) that translates one of a plurality of software application notifications to one of the plurality of pre-determined signals; and
a software application that incorporates the SDK, receives notifications from one or more other software applications, and is wirelessly connected with the lamp driver.

22. A visual notification device comprising:
a plurality of colored lamps that are spaced apart within a light bar body;
a lamp driver that is housed in the light bar body and receives one of a plurality of pre-determined signals and individually controls one or more of the plurality of lamps in response to the received signal; and
a wireless transceiver that is housed in the light bar body and connected in communication with the lamp driver for delivering the received signal to the lamp driver.

23. The device of claim 22, further comprising a software developer kit (SDK) that translates one of a plurality of software application notifications to one of the plurality of pre-determined signals.

24. The device of claim 23, further comprising a software application that incorporates the SDK, receives notifications from one or more other software applications, and is wirelessly connected with the lamp driver via the wireless transceiver.
